(19) United States
(12) Patent Application Publication
(10) Pub. No.: US 2012/0058407 A1
(43) Pub. Date: Mar. 8, 2012

(54) Cooling Devices for a Fuel Cell System

(75) Inventors: Oliver Harr, Reichenbach (DE); Cosimo Mazzotta, Ulm (DE); Armin Muetschele, Weilheim (DE); Holger Richter, Kirchheim (DE); Hans-Joerg Schabel, Reutlingen (DE)

(73) Assignee: Daimier AG, Stuttgart (DE)

(21) Appl. No.: 13/257,187

(22) PCT Filed: Mar. 9, 2010
(86) PCT No.: PCT/EP2010/001450

§ 371 Date: Oct. 25, 2011

(30) Foreign Application Priority Data
Mar. 18, 2009 (DE) 102009013776.9

(51) Int. Cl. H01M 8/04

(52) U.S. Cl. 429/439

(57) ABSTRACT

A cooling device for a fuel cell system includes at least one cooling circuit, through which a fuel cell can be cooled. The fuel cell system also includes a component with at least an electric drive area and a gas delivery area. A gas can be delivered to the fuel cell through the gas delivery area and the component is actively cooled. The cooling of the component takes place together with the cooling of the fuel cell in a cooling circuit.

### BACKGROUND AND SUMMARY OF THE INVENTION

The invention relates to a cooling device for a fuel cell system with at least one cooling circuit through which a fuel cell can be cooled, and with at least one component which comprises at least an electric drive area and a gas delivery area, wherein a gas can be delivered through the gas delivery area to the fuel cell. The invention further relates to the use of such a cooling device in a fuel cell system for driving a transport means.

Fuel cell systems for generating electrical energy from gaseous educts such as, for example, hydrogen and oxygen or air are known from the general prior art. Transport means, such as for example in motor cars and utility vehicles, are frequently equipped with a so-called low temperature fuel cell as a core element of the fuel cell system. A common type of such a low temperature fuel cell is, for example, the so-called PEM fuel cell, which is generally operated at a temperature level of 60-90° C. In order to ensure this temperature level of the fuel cell during operation, the fuel cell system usually comprises a cooling circuit which removes excess waste heat from the region of the fuel cell and from the region of other components. The other components can thereby be components of the fuel cell system, for example an air delivery component or a hydrogen recirculation blower, in order to return unused hydrogen from a region after the anode of the fuel cell into the region before the anode of the fuel cell. The recirculated unused hydrogen is mixed there with fresh hydrogen, for example from a compressed gas tank, and fed again to the anode of the fuel cell. Besides such components, which are to be assigned directly to the fuel cell system, further components requiring cooling can also be present, in particular electrical and/or electronic components for the drive of the transport means. In a very large number of systems a further cooling circuit is therefore provided, as electrical and electronic components in particular, such as for example power electronic components or electric motors, generally have a better performance capacity and a longer lifespan if they are cooled to a correspondingly low temperature level. Therefore, the second cooling circuit typically has a lower temperature level than the cooling circuit for the fuel cell and serves for cooling of these components.

It is additionally known in fuel cell systems that the educts flowing to the fuel cell must contain a certain amount moisture to avoid drying out of the fuel cell. The products flowing away from the fuel cell, thus in general the waste air from the cathode area and the unused gas flowing from the anode area, which is recirculated via the hydrogen recirculation blower, additionally comprise in the fuel cell product water formed from hydrogen and oxygen. The fact that gases flow through the line elements of a fuel cell system that have a high moisture content and/or liquid droplets is extraordinarily critical with regard to the shutdown and, in particular, with regard to a later re-start of the fuel cell system at temperatures below freezing point. Indeed the liquid droplets forming in the lines can freeze under these conditions and lead to considerable problems upon re-starting. In particular, in the region of the air delivery component and the hydrogen recirculation blower, freezing of water droplets inside the gas delivery area can arise. Particularly with flow compressors and blowers, the vane elements required to convey the gas can thereby freeze solid on the walls of the gas delivery area. Upon re-start of the fuel cell system the corresponding component cannot then function but must instead first be thawed before it can perform its intended function, require can require a lot of time and expenditure of energy resources.

In order to reduce this problem, German Patent document DE 103 14 820 A1 expels this “dangerous” moisture by a dry scavenging gas so that the gases present in the system are so dry that the abovementioned problem cannot arise. A somewhat different approach to solving this problem is provided by Japanese Patent document JP 2008 041433 A, wherein through the operation of the hydrogen recirculation, blower heating and drying of the gases is achieved at least in the anode circuit. Both solutions have the disadvantage that they require additional energy or corresponding connections and components in order to convey a dry gas through the corresponding line regions upon disconnection. In addition, both structures have the disadvantage that they should only be used—for energy reasons alone—if a disconnection is actually in place for a correspondingly longer period. This means that the required control necessitates comparatively high resources and causes unnecessary energy losses in case of a rapid re-start of the fuel cell system.

Exemplary embodiments of the present invention provide a cooling device for a fuel cell system that avoids these disadvantages and is still in a position to avoid the abovementioned problems in relation to possible freezing of components actively cooled during operation which convey gases in the fuel cell system.

The inventive cooling of the component together with the fuel cell in a cooling circuit has the advantage that the component is cooled at a relatively high temperature level. The electronic components in a gas delivery component thereby have a structure which is by far not as complex as in other power electronic components, for example a drive controller for a drive, a DC/DC converter or similar. Therefore, they can be constructed comparatively simply and cost-effectively so that they can also withstand this higher temperature level over a fairly long time period without damage. However, cooling of the component at the higher temperature level of the fuel cell itself ensures that, upon disconnection of the system that the component cools more slowly in relation to the line elements surrounding it, as in operation it had a correspondingly high temperature level and stores the heat longer due to its mass than for example a line element. This ensures that the fuel cell and at least the at least one component cool more slowly than the areas surrounding them in the form of other components, line elements or similar. Upon cooling, the moisture is then removed into these areas, which cool correspondingly more rapidly, and condenses there. The risk of droplets condensing in the region of the component can thus be greatly reduced without notable additional resources so that upon re-start under freezing conditions the problem described at the start will no longer arise. Compared to the prior art, this can be achieved without additional components for heating, flushing or similar. In addition, the effect is produced during operation of the fuel cell system with such a cooling device automatically so that this is always available independently of the duration until the re-start and without additional control resources.

According to a further favorable embodiment of the inventive cooling device a further cooling circuit is present at a lower temperature level, through which electronic components not located in the region of the component and/or further auxiliary units can be cooled.

This structure provides for the combination, described above and known from the prior art, of a fuel cell system with a low temperature and high temperature cooling circuit. The low temperature cooling circuit thereby cools in particular the components of the drive electronics, electronic inverters and similar. The at least one component with the gas delivery component that would be cooled as an electronic component in the conventional structure, and additionally by this low temperature cooling circuit is now, however, displaced into the high temperature circuit for cooling of the fuel cell itself. This ensures that the component is at a higher temperature during operation. It thus cools upon shutdown of the system correspondingly more slowly so that moisture does not condense in the gas delivery area of the component but instead in the regions surrounding the component, for example, the line elements. If temperatures lie below freezing point, droplets can indeed freeze solid in the surrounding regions on the walls of the line elements. Since in the gas delivery area, however, no liquid condenses, freezing cannot arise there and in particular not freezing solid of the gas delivery medium in this region.

According to a favorable and advantageous embodiment of the inventive cooling device the at least one component comprises a thermal insulation.

The inventive effect that, through the cooling of the at least one component in the cooling circuit at a higher temperature level, this component has a higher temperature upon shutdown of the fuel cell system and thereby cools more slowly can be further intensified through a thermal insulation of the component. With this simple, cost-effective and passive means the cooling of the component can be slowed down further after shutdown of the fuel cell system so that condensation of liquid in the gas delivery area of the component becomes even more improbable than in the cases already described above.

The inventive cooling device for a fuel cell system is particularly suited for fuel cell systems that are frequently started, stopped and started again and that are thereby also in regions wherein, due to the low temperatures, there is the risk of freezing of condensed water. A particularly favorable and advantageous use of the inventive cooling device for fuel cell systems can thus be seen with fuel cell systems which are used to drive transport means.

Such drive systems are subject to frequent starting and stopping and can, at certain latitudes, also frequently be exposed to temperatures below freezing point. As in addition the most efficient use possible of energy for the driving of transport means plays an increasingly great role, the above-mentioned advantages can be particularly valid in this use. In addition, it is possible in a simple, robust and reliable way with the use of the inventive cooling device to stop a fuel cell system with ideal conditions for a re-start under freezing conditions. This also predestines the structure for use in transport means.

Transport means according to the meaning of the invention should be understood to include various types of transport means on land, in water and in the air, in particular vehicles for conveying persons or goods, vehicles in the field of logistics, ships or submarines. Likewise, use in aircraft is conceivable, whereby the electrical energy is not typically used here to propel the aircraft but instead to drive subsidiary units.

Further advantageous embodiments of the invention follow from the remaining dependent claims and from the example embodiment which is explained in greater detail below with the aid of the drawings.

### BRIEF DESCRIPTION OF THE DRAWING FIGURES

The drawings thereby show:

FIG. 1 an example fuel cell system in an indicated vehicle;

FIG. 2 a cooling device according to the invention in a first embodiment; and

FIG. 3 a high temperature cooling circuit according to the invention in a second embodiment.

### DETAILED DESCRIPTION

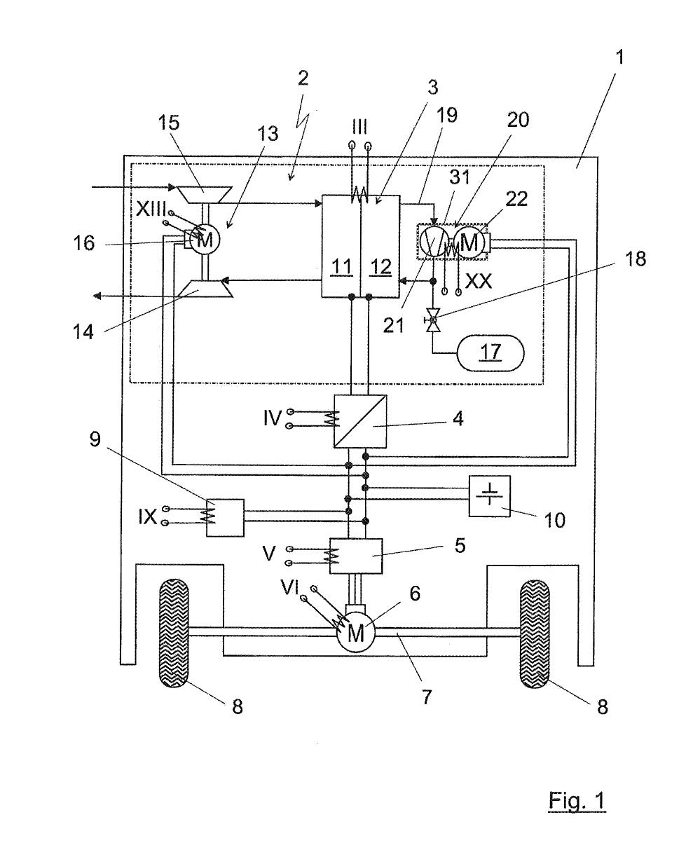

FIG. 1 shows a highly schematized vehicle 1 as an example transport means. The vehicle 1 is equipped with a fuel cell system 2 which is edged by a dotted line. A fuel cell 3 as the core element of the fuel cell system 2 provides electrical power, which is made available via a DC/DC converter 4 or another comparable electronic component to an on-board network of the vehicle 1. The electrical power thereby serves primarily to drive the vehicle 1, which is indicated here correspondingly via a power electronic unit 5 and an electric motor 6. By means of an axle 7, wheels 8 of the vehicle 1 are driven in the schematic illustration selected here by the electric motor 6. The electrical power generated by the fuel cell 3 can additionally be made available to further electric or power electronic elements which are indicated here by the box 9 by way of example. Furthermore an accumulator device 10 can be provided for electrical energy, for example in the form of a battery and/or a high power condenser.

The fuel cell 3 is to be formed in the exemplary embodiment shown here as a stack of individual PEM (polymer electrolyte membrane) fuel cells. The fuel cell 3 comprises a cathode chamber 11 and an anode chamber 12, which are separated from each other by a polymer membrane as an electrolyte. By means of an air delivery component 13, air is fed as an oxygen containing gas to the cathode chamber 11 of the fuel cell 3. The used waste air then passes in this example embodiment of the fuel cell system 2 from the cathode chamber 11 into a turbine 14, in which it is expanded, before it is discharged to the environment of the vehicle 1. The air delivery component 13 comprises, besides a delivery area 15 and an electrical machine 16, also this turbine 14 which has just been described. The whole structure of the air delivery component 13 shown here by way of example is also known as an electric turbocharger (ETC). By means of the turbine 14, energy can thereby be recovered from the waste air so that not all the energy necessary for conveying the air has to be provided by the electrical machine 16. If, in special cases, an energy excess arises at the turbine 14 so that more energy is available at the turbine 14 than is required for the delivery of the air in the air delivery area 15, which is typically formed as a flow compressor, energy can also be recovered via the electrical machine 16 in generating operation and fed to the on-board network of the vehicle 1.

The supply of the anode chamber 12 of the fuel cell 3 takes place in the embodiment shown here with hydrogen that is stored in a compressed gas tank 17 in the vehicle 1. By means of a corresponding dosing valve 18, which will typically comprise a pressure reducing element, the hydrogen is fed from the compressed gas tank 17 to the anode chamber 12 of the fuel cell 3. In order to supply all regions of the anode chamber 12 of the fuel cell 3 evenly with hydrogen and thereby to ensure a good performance capacity of the fuel cell 3, more hydrogen is usually dosed into the fuel cell 3 than can be consumed in it. The excess hydrogen is fed from the region of the anode chamber 12 via a recirculation line 19 and a recirculation delivery component 20, which will usually be formed as a hydrogen recirculation blower with a gas delivery area 21 and an electric drive motor 22. The recirculation delivery component 20 thereby supports the recirculation of the unused anode waste gas. This is then mixed with the fresh hydrogen coming from the compressed gas tank 17 and is fed as a common hydrogen flow again to the anode chamber 12 of the fuel cell 3.

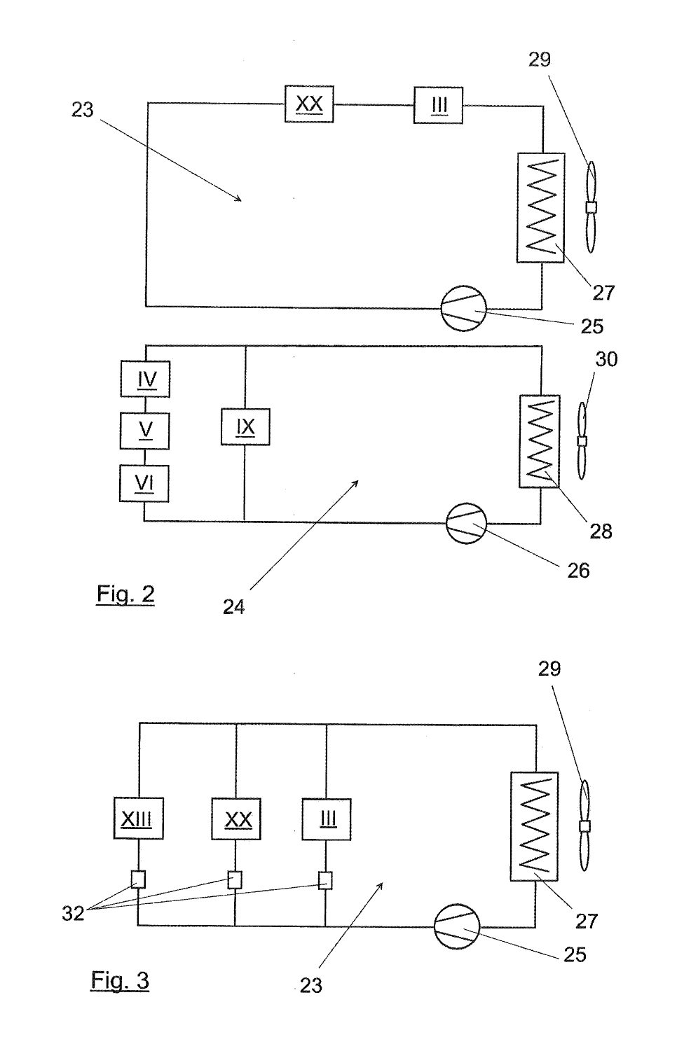

In such a fuel cell system 2 and in the electrical and/or electronic components of the vehicle, waste heat normally arises in operation that must be actively removed. For this active cooling the vehicle 1 usually comprises two cooling circuits 23, 24 which are shown by way of example in FIG. 2. The cooling circuits 23, 24 are thereby divided into a high temperature cooling circuit 23 and a low temperature cooling circuit 24. The temperature of the high temperature cooling circuit 23 will lie in the range of the typical temperature level for operation of the fuel cell 3, thus at around 60-90° C. The temperature of the low temperature cooling circuit 24 will be lower than this temperature level as the cooling circuit 24 is used to cool electrical and/or electronic or power electronic components which can generally be realized more simply, more cost-effectively and with a higher lifespan if they are cooled to a temperature level that lies below the temperature level of the high temperature cooling circuit. Typical temperature levels for the low temperature cooling circuit lie accordingly below 60° C.

In the representation of the vehicle 1 in FIG. 1 heat exchangers are now indicated on different components and provided with the Roman numeral corresponding to the Arabic number of the component. These heat exchangers III, IV, V, VI, IX, XIII and XX constitute, for example, the most important components of the fuel cell system 2 and the on-board network or drive of the vehicle 1 to be cooled.

In the representation of the cooling circuits 23, 24 of FIG. 2 it can be seen that each of the cooling circuits has a cooling medium delivery component 25, 26 and a cooling heat exchanger 27, 28. The cooling heat exchangers 27, 28 are thereby comparable with the vehicle cooler in conventional vehicles equipped with an internal combustion engine. The head wind usually impacts them and they cool the cooling medium flowing in the cooling circuits 23 and 24. There can, if required, also be a flow to them via fans 29, 30 indicated by way of example in order to improve the cooling of the cooling medium in the respective cooling circuit 23, 24.

As can be seen in the illustration of FIG. 2, the high temperature cooling circuit 23 cools the fuel cell 3, which is indicated here by the box with the designation III, which symbolizes the heat exchanger III in the region of the fuel cell 3. In addition the cooling medium flows in a series arrangement through the heat exchanger XX of the recirculation delivery component 20 before it flows through the heat exchanger III of the fuel cell 3. In the further cooling circuit 24 at the lower temperature level the heat exchangers IV, V, VI of the DC/DC converter 4, of the power electronic unit 5 of the drive and of the drive motor 6 are shown for example in a series arrangement. Besides this, the cooling medium flows in a parallel branch indicated by way of example through the heat exchanger IX of the further electrical and/or electronic components 9. The representation of the heat exchanger XIII of the air delivery component 13 has been omitted in FIG. 2. This could in principle be arranged both in the high temperature circuit 23 and in the low temperature circuit 24.

As already mentioned at the start, at temperatures below freezing point it is particularly problematic when moist gas or gas with liquid droplets is present in the region of the line elements of the fuel cell system 2. Indeed, upon cooling of the fuel cell system 2 after shutdown, condensation or collection of this moisture can arise. If moisture collects in the gas delivery area 21 of the recirculation delivery component 20, in the air delivery area 15 or the turbine 14 of the air delivery component 13, this can lead to freezing solid of the delivery medium of the regions 14, 15, 21 typically formed as flow compressors or blowers. This is particularly problematic in the recirculation delivery component 20, as a relatively high moisture is present here in the recirculated anode waste gas. To a certain extent the problem also arises in the air delivery component 13 but fresh air is drawn in from the environment here, which at this time still does not have a moisture content which is all too high. The region of the turbine 14 is more problematic in the region of the air delivery component 13, as also here waste gas loaded with product water flows from the cathode region, which also brings very much moisture with it which can condense correspondingly in this region.

With respect to the example of the hydrogen circulation blower 20, it will now be described how this effect can be prevented or clearly reduced. This can then be correspondingly transferred to the air delivery component 13 with the air delivery area 15 and the turbine 14, whereby the problem is not as great as in the gas delivery area 21 of the recirculation delivery component 20.

Due to the fact that the cooling of the recirculation delivery component 20 takes place via the heat exchanger XX actively in the high temperature cooling circuit 23, it is ensured that the recirculation delivery component 20 is operated as a component of the fuel cell system 2 at a comparatively high temperature level. As the combination of the recirculation delivery component 20 with the gas delivery area 21 and the electric drive motor 22 has a comparatively high mass, the whole mass will heat during the operation of the fuel cell system 2 to a temperature corresponding approximately to the temperature level of the high temperature cooling circuit 23. It is thus ensured that upon shutdown of the fuel cell system 2 the recirculation delivery component 20 is at a relatively high temperature level and cools correspondingly slowly. In particular, due to its larger mass, it will cool more slowly than the regions adjacent to it, in particular than the line elements adjacent to it. Condensation of liquid in the moist gas of the anode recirculation line 19 is thereby avoided in the region of the recirculation delivery component 20. Indeed, the moisture will condense more in the adjacent regions, in which a lower temperature level was present and which correspondingly cool more quickly. The formation of condensate in the gas delivery area 21 of the recirculation delivery component 20 is thereby extensively avoided so that the risk of freezing solid of the delivery component is avoided or at least clearly reduced. In order to further slow down the slow cooling of the recirculation delivery component upon shutdown of the fuel cell system 2 a thermal insulation 31 can also be provided in the region of the recirculation delivery component 20, as schematically indicated in FIG. 1. The risk of the moisture now condensing in the region of the fuel cell 3 itself and freezing there is thereby comparatively low, as the fuel cell 3 itself also lies at the temperature level of the high temperature cooling circuit 23 and as the fuel cell cools slowly anyway with a comparatively large mass. In addition, the fuel cell 3 itself can also be provided with a thermal insulation but which is not shown here.

Besides the slow cooling, a further additional positive effect is achieved through the operation of the recirculation delivery component 20 or its cooling at the high temperature level of the high temperature circuit 23. The moisture in the fuel cell system 2 or in the lines of the fuel cell system 2 will inevitably always condense in a certain proportion where components are actively cooled and during operation are correspondingly cooler than their environment. Through the cooling of the recirculation delivery component 20 at a higher temperature level than has been usual to date, the condensation of liquid is also correspondingly reduced during operation in the region of the recirculation delivery component 20 and thus in the region of the recirculation line 19 and the anode chamber 12 itself. Less water thereby arises in liquid form that must be let out of the system through separators or similar. This is advantageous for the operation of the system as it improves the system performance with simultaneous sufficient moistening of the membrane in the fuel cell 3 and as when removing water, in particular if this takes place together with the gas from the region of the recirculation line 19, a certain quantity of hydrogen is always lost. Removal which is as seldom as possible thus has advantages in relation to energy and emissions.

The idea described in detail by reference to the recirculation delivery component 20 can now likewise be transferred to the air delivery component 13 with its air delivery area 15 and the turbine 14. The described effect can also be achieved here through cooling at the temperature level of the high temperature cooling circuit 23 and possibly a thermal insulation. In the representation of FIG. 3 a structure is therefore described, wherein the high temperature cooling circuit 23 is again shown in a different embodiment. The low temperature cooling circuit 24 is present here also in parallel, but is not shown again in order to simplify the representation. In the cooling circuit 23 the cooling heat exchanger 27, the cooling medium delivery component 25 and the fan 29 can in turn be seen. Instead of the serial flowing, described above, of the cooling medium through the heat exchangers XX and III, the cooling medium flows in parallel through the heat exchangers XIII of the air delivery component 13, XX of the recirculation delivery component 20 and III of the fuel cell 3 in the cooling circuit 23. The distribution of volume flows of the cooling medium in the cooling circuit 23 to the individual heat exchangers XIII, XX and III can take place through suitable diaphragms and/or valve component 32 in the individual strands of the cooling circuit 23. Besides the variant shown here with three diaphragms or valve component 32, it would naturally also be conceivable to provide merely two of the strands with the diaphragms, as this would also facilitate a targeted regulation of the through-flow of the individual strands and thus the cooling of the individual cooling heat exchangers XIII, XX and III.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-16. (canceled)

17. A cooling device for a fuel cell system, comprising:
a cooling circuit through which a fuel cell can be cooled; and
at least one component comprising at least an electric drive area and a gas delivery area, wherein a gas can be delivered through the gas delivery area to the fuel cell, and wherein the at least one component is actively cooled,
wherein the at least one component and the fuel cell are arranged in the same cooling circuit.

18. The cooling device according to claim 17, wherein the cooling circuit has a temperature level of 60-90° C.

19. The cooling device according to claim 17, wherein the cooling circuit comprises a cooling medium delivery component in series with a cooling heat exchanger.

20. The cooling device according to claim 17, further comprising:
a further cooling circuit, operating at a lower temperature level than the cooling circuit, that includes electrical or electronic components not located in a region of the at least one component or further auxiliary units, the further cooling circuit configured to cool the electrical or electronic components.

21. The cooling device according to claim 20, wherein the further cooling circuit comprises a cooling medium delivery component in series a cooling heat exchanger.

22. The cooling device according to claim 17, wherein the at least one component and the fuel cell are arranged in series one behind the other in the cooling circuit.

23. The cooling device according to claim 17, wherein the at least one component and the fuel cell are arranged parallel to each other in the cooling circuit.

24. The cooling device according to claim 17, wherein the at least one component is a recirculation delivery component or air delivery component.

25. The cooling device according to claim 17, wherein the at least one component includes a first and second component, the first component is a recirculation delivery means component and the second component is an air delivery component.

26. The cooling device according to claim 24, wherein the air delivery component is an electric turbocharger.

27. The cooling device according to claim 25, wherein the air delivery component is an electric turbocharger.

28. The cooling device according to claim 25, wherein the first and second components are arranged parallel to each other in the cooling circuit.

29. The cooling device according to claim 17, wherein the at least one component comprises a thermal insulation.

30. The cooling device according to claim 17, wherein the fuel cell comprises a thermal insulation.

31. The cooling device according to claim 30, wherein non-thermally-insulated regions in the fuel cell system are arranged in fluid connection adjacent to the at least one component or the fuel cell.

32. A method of operating a cooling device, comprising cooling, using at least one cooling circuit, a fuel cell and at least one component comprising at least an electric drive area and a gas delivery area, wherein a gas is delivered through the gas delivery area to the fuel cell, wherein the component is actively cooled, and wherein the at least one component and the fuel cell are cooled by the same cooling circuit.

33. The method according to claim 32, wherein a further cooling circuit, operating at a lower temperature level, cools electrical or electronic components and components.
